(19) United States
(12) Patent Application Publication
(10) Pub. No.: US 2023/0166939 A1
(43) Pub. Date: Jun. 1, 2023

(54) LAYING-PIPE SEGMENT, LAYING-PIPE HOLDER AND ARRANGEMENT OF A LAYING-PIPE HOLDER AND A LAYING PIPE

(71) Applicant: SMS group GmbH, Duesseldorf (DE)

(72) Inventors: Bodo VIELAND, Moenchengladbach (DE); Peter HAAK, Moenchengladbach (DE)

(73) Assignee: SMS group GmbH, Duesseldorf (DE)

(21) Appl. No.: 17/994,639

(22) Filed: Nov. 28, 2022

(30) Foreign Application Priority Data
Dec. 1, 2021 (DE) 10 2021 131 564.6
Jan. 26, 2022 (DE) 10 2022 101 819.9

(51) Int. Cl. B65H 57/12; B21C 47/34; B33Y 80/00

(52) U.S. Cl. CPC B65H 57/12; B21C 47/34; B33Y 80/00; B65H 2701/36; B65H 2404/6111

(57) ABSTRACT

A laying-pipe segment is produced using an additive manufacturing method, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment.

### CROSS REFERENCE TO RELATED APPLICATIONS

Applicant claims priority under 35 U.S.C. § 119 of German Application No. 10 2021 131 564.6 filed on Dec. 1, 2021 and German Application No. 10 2022 101 819.9 filed on Jan. 26, 2022, the disclosures of which are incorporated by reference.

### BACKGROUND OF THE INVENTION

### 1. Field of the Invention

The invention relates to a laying-pipe segment for laying a workpiece guided through a laying-pipe segment, a laying-pipe holder and an arrangement of a laying-pipe holder and a laying pipe.

### 2. Description of the Related Art

Laying pipes have in practice a configuration bent into suitable form, in order in this way to deposit a wire or another very long workpiece provided in elongated geometry in loops on a preferably moving deposition surface. As a rule, these laying pipes rotate around a central body and in the process deviate in particular from a linear configuration. Since the length and bent form of the laying pipe is not easy to produce by manufacturing technology, the laying pipes from the prior art, such as known, for example, from WO 2013/048772 A1, from WO 2013/048805 A1 and from WO 2013/048800 A1, are manufactured from several laying pipe segments, which when assembled form the complete laying pipe. In the process, each individual one of the laying-pipe segments has to be bent only slightly. In assembled condition, the laying-pipe segments form a laying pipe having the desired form, which could hardly be achieved on the whole by the bending of an individual long laying pipe. A wire-winding laying head for depositing an appropriately guided workpiece is disclosed in DD 143 142. In particular, WO 2013/048805 A1 discloses initial notions in this regard for manufacturing laying pipes by means of additive manufacturing methods.

The laying-pipe segments are exposed to a particularly severe wear, since corresponding tubes or bars that slide through the laying pipe are changed in their alignment and accordingly rub on the laying pipe. For this reason, a replacement of the laying pipe at regular intervals is necessary.

### SUMMARY OF THE INVENTION

It is the task of the present invention to permit an individual configuration of wearing regions of a laying pipe and of a laying-pipe holder or a simple adaptation even to a very complex course of the laying-pipe axis.

The task of the invention is accomplished by a laying-pipe segment and by a laying-pipe holder as well as by an arrangement of a laying-pipe holder and a laying pipe having the features of the independent claims. Further advantageous configurations, possibly even independent thereof, are presented in the dependent claims as well as the following description.

In order to permit an individual configuration of wearing regions of a laying pipe or a simple adaptation even to a very complex course of the laying-pipe axis, a laying-pipe segment, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment, may be characterized in that the laying-pipe segment is produced by means of an additive manufacturing method.

In the present connection, a “laying pipe” may preferably be understood as a pipe that is used to deposit a workpiece. A workpiece that is deposited by a laying pipe is usually a round workpiece, such as a bar or a wire, for example. This is appropriately manufactured and formed before it arrives at the laying pipe. The laying pipe is used in the last step to place the workpiece in controlled manner. In the present connection, this may preferably take place in such a way that the workpiece is guided through the laying pipe and then deposited or coiled in a circular area. This may take place in particular on a moving deposition surface.

In the present connection, a “laying-pipe segment” may be understood as a tubular segment that forms the laying pipe all by itself or in combination with other segments and thus is part of the laying pipe. The material, the properties and the dimensioning of the laying pipe are accordingly determined by the corresponding configuration of the laying-pipe segment or of the laying-pipe segments.

In the present connection, the “laying-pipe segment length” describes the length of a laying-pipe segment, wherein, however, the length along the respective laying-pipe segment is measured by following its curvature and in particular not along the direct line between the beginning and the end of the laying-pipe segment. The latter coincides with the laying-pipe segment length only if the laying-pipe segment is configured linearly.

Accordingly, the laying-pipe length then describes the total length of the laying pipe over its individual laying-pipe segments, wherein the laying-pipe length is identical to the laying-pipe segment length in only one laying-pipe segment.

A “laying-pipe segment axis” can be defined preferably as a trajectory, extending along the inside opening or the generating line, of all midpoints of the inside cross section or of the outside cross section. Beyond this, however, the laying-pipe segment axis may also be defined as a trajectory, extending along the inside opening or the generating line, of all centers of gravity, geometric centroids of area or geometric centroids of outer circumference lines of the respective trajectory perpendicular to the laying-pipe segment axis or to the aforesaid trajectory. Beyond this, the laying-pipe segment axis may also be defined in the present connection as the trajectory, extending along the inside opening or the generating line, of all points lying on an idealized or calculated line. In this context, it is possible that projections that may be applicable or that possibly are formed in one piece, for example for construction of contact points, holders, etc. may be averaged out by interpolation or not be taken into consideration. The exact choice of definition of the laying-pipe segment axis should not play a role in the present case, however, since corresponding deviations due to this choice of the definition are either irrelevant or may be back-calculated by changing the coordinate system. In a comparison of various laying pipes or laying-pipe segments, however, it is recommended that respectively congruent definitions be chosen.

It will be understood that, accordingly, a laying-pipe axis may be defined that corresponds to the laying-pipe segment axis of the laying-pipe segments forming the laying pipe.

Accordingly, it is possible to define a laying-pipe segment cross section or a laying-pipe cross section perpendicular to the laying-pipe segment axis or to the laying-pipe axis. An outside diameter and an inside diameter may then be measured or defined in the plane of the respective laying-pipe segment cross section or laying-pipe cross section. In this connection, it is also conceivable that, especially for the outside diameter, any special structures that are provided, such as holder or air lines and the like, are not taken into consideration or are lost by interpolation or lost by averaging during determination of the respective diameter.

Since the laying pipe as well as also the laying-pipe segment are formed as pipes, they have an outside diameter and an inside diameter, by the difference of which a wall thickness is determined, which indicates the respective thickness of the pipe wall of the laying-pipe segment or of the laying pipe.

In the present connection, the term “additive manufacturing method” denotes all manufacturing methods in which a material is applied layer by layer or by dots and thus three-dimensional objects are generated. In the process, the buildup in layers or dots usually takes place in computer-controlled manner from one or more liquid or solid materials according to specified sizes and shapes. During buildup, physical or chemical hardening or melting processes take place. Typical materials for the additive manufacturing methods are plastics, synthetic resins, ceramics and specially conditioned metals. Additive manufacturing methods are preferably used in industry, in model construction and the research for manufacture of models, samples, prototypes, tools, final products and for private use. In addition, applications exist in the home and entertainment sector, the construction industry as well as in the art and medicine.

In practice, numerous additive manufacturing methods or technologies exist, wherein they may be advantageously classified in various categories: polymerization of liquids, such as in stereolithography, (SLA), for example; material extrusion, such as fused-layer modeling/manufacturing (FLM), for example; material jetting; binder jetting; powder-bed fusion, such as multi-jet fusion (MJF), selective laser sintering (SLS) or direct metal sintering/selective laser melting (DMLS/SLM), for example; directed energy deposition; electron beam additive manufacturing (EBAM); and film lamination, such as laminated object manufacturing (LOM), for example. In this context, the different manufacturing methods are characterized by different advantages and disadvantages as well as different areas of use. Thus certain materials, such as plastic or metal, could be processed better or even at all with some methods, while other methods are rather unsuitable for this purpose.

At first sight, the manufacture of a pipe such as the laying-pipe segment by additive manufacturing methods does not seem advantageous, since such manufacturing methods do not appear suitable at first sight for long and severely loaded component parts. It has been found, however, that precisely additive manufacturing methods are applicable for the geometries desired for laying pipes and surprisingly offer possibilities in the configuration of the respective laying-pipe segments that permit entirely new configurations of the laying pipes.

Preferably the laying-pipe segment has a gradient of the laying-pipe segment properties along the laying-pipe segment axis and/or along the laying-pipe segment cross section. Hereby a partial adaptation of regions of a laying-pipe segment is possible, such as, for example, for a higher wear resistance in a region of heavy rubbing or abrasion, in order to reinforce this region partly against this. This is the case both along the pipe axis and in the cross section. Depending on specific implementation, the vibrational properties may also be influenced in positive manner hereby, for example for reduction of natural vibrations or even for targeted use of natural vibrations, for example in order to assist deposition in the desired form. In particular, it is also possible to adapt less stressed regions appropriately in their properties, in order, for example, to enhance the elasticity or the stability of the more severely stressed region with respect to the vibrational properties.

Preferably, the progression of the change of a variable on a particular trajectory can be understood as the “gradient” in the present connection. In the present case, the particular variable may accordingly be at least one laying-pipe segment property, so that the laying-pipe segment properties correspondingly have a changing progression along the laying-pipe segment axis, meaning that different laying-pipe segment properties exist along the laying-pipe segment axis.

In the present connection, preferably the dimensioning of the laying-pipe segment, such as the wall thickness, for example may be understood as the “laying-pipe segment properties”. All material characteristics may also be interpreted as the laying-pipe segment properties. Since the laying pipe is manufactured from a particular material, it also has particular material characteristics corresponding to the material being used, which characteristics may then vary correspondingly along the laying-pipe segment axis, thus representing a gradient of the laying-pipe segment properties. Likewise, materials may be appropriately varied or changed, in order to provide a gradient of the laying-pipe segment properties.

The material characteristic is preferably a physical variable, with which a material may be characterized. Material characteristics may be determined experimentally by a series of measurements or a material test and may describe in particular physical or physicochemical properties of materials. A characteristic reflects typical behavior of a material and is also frequently indicated as an interval. The material characteristics can be subdivided into mechanical, thermodynamic, electrodynamic and optical material characteristics.

Examples of the mechanical material properties, and thus also of laying-pipe segment properties, can be the modulus of elasticity, the shear modulus, the yield point, the offset yield strength, the tensile strength, the compressive strength, the fatigue strength under reversed bending loads, the vibration resistance, the high-temperature strength, the critical shear stress, the yield stress, the fracture and crack toughness, the elongation without necking, the elongation at break, the reduction of area at break, the hardness, the notch impact strength and the speed of sound. Thus the wear resistance, for example, of a laying-pipe segment may be optimized in partial regions by the appropriate mechanical material characteristics.

Examples of the thermodynamic material characteristics can be melting point, thermal conductivity, specific heat capacity and coefficient of expansion.

The electrodynamic material characteristics can include, among others, the electrical conductivity and the specific resistance.

Especially by an additive manufacturing, the material characteristics and further laying-pipe segment properties may be appropriately varied by a variation of the local composition of the material.

Cumulatively or alternatively to this, the laying-pipe segment may have a gradient of the laying-pipe segment properties along an angle of rotation in order to achieve the same advantages. The angle of rotation is disposed here around the laying-pipe segment axis in the laying-pipe segment cross section.

By this gradient of the laying-pipe segments properties, it is conceivable for a laying-pipe segment to have as many regions as desired with respectively different laying-pipe segment properties. By the manufacturing by means of an additive manufacturing method, wearing regions of the laying-pipe segment can be configured in particularly simple manner with different laying-pipe segment properties.

It is of advantage when the wall thickness of the laying-pipe segment varies along the laying-pipe segment axis, since in this way thicker wall thicknesses, for example, may be provided in a region of high mechanical stresses. Cumulatively or alternatively to this, the wall thickness of the laying-pipe segment may also be varied along the laying-pipe segment cross section in order to achieve the same advantage. In addition, the wall thickness of the laying-pipe segment may also vary along the angle of rotation, in order to achieve the advantages mentioned in the foregoing.

The extent of the laying-pipe segment and thus also the extent of the wall thickness exist in three dimensions, so that the gradient of the laying-pipe segment properties can also exist in three dimensions, which can also be implemented by an additive manufacturing method.

In particular, the material properties of the laying-pipe segment may also vary along the laying-pipe segment axis. Hereby it is possible, for example, for the material characteristics such as the modulus of elasticity, the density, the hardness, the compressive strength and the flexural strength to be partly adapted and for the laying-pipe segment to be correspondingly generated in the manufacturing process. By the manner in which the additive manufacturing methods function, the material properties may be incorporated into the laying-pipe segment in the corresponding regions as early as during manufacturing. The material properties of the laying-pipe segments extend here in three dimensions, so that the gradient may also extend preferably in three dimensions. In particular, various layers having correspondingly varying layer thicknesses or only special layers of particular materials or material combinations at particular places may also be provided, whereby the material properties may also be individually adapted. Alternatively or cumulatively to this, the material properties of the laying-pipe segment may also vary along the laying-pipe segment cross section in order to achieve these same advantages. Beyond that, the material properties of the laying-pipe segment may also vary along the angle of rotation, in order to achieve the said advantages.

It is advantageous when the laying-pipe segment is formed with flowing material progressions. By “flowing material progression”, preferably a continuous gradient of the material progression within a laying-pipe segment may be understood in the present connection, wherein the segment in itself is nevertheless formed in one piece, which actually is possible only by the additive manufacturing. Thus, several pieces are not necessary in order to achieve a gradient within a pipe of several segments, but a gradient within one segment is also possible. By the flowing material progression, all laying-pipe segment properties may also be configured in flowing manner hereby.

In order to permit an individual configuration of wearing regions of a laying pipe or a simple adaptation even to a very complex course of the laying-pipe axis, a laying-pipe segment, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment, may also be characterized in that the laying-pipe segment is formed in one piece with at least one part of a wall of a cooling channel.

Cumulatively or alternatively to this, a laying-pipe segment, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment, may also be characterized in that the laying-pipe segment is formed in one piece with at least one part of a wall of a cooling channel, in order to permit an individual configuration of wearing regions of a laying pipe or a simple adaptation to a very complex course of the laying-pipe axis.

The formation of the laying-pipe segment in one piece with at least one part of a wall of a cooling channel or a cooling line ensures a particularly effective cooling, since coolant that flows through the cooling channel or the cooling line flows very closely past the laying-pipe segment. The more closely the cooling fluid is in contact with the wall of the laying-pipe segment, the more effective is the cooling on the laying-pipe segment. Beyond that, no external and usually more complex cooling systems are needed any longer, since an appropriate cooling system by the cooling channel or the cooling line is provided directly with the laying pipe. Such a configuration is also particularly space-saving, since external cooling systems must still be disposed in one way or another outside the laying-pipe segment and, depending on the spatial circumstances, are difficult to integrate. In contrast, the additive manufacturing methods make it possible to form appropriate cooling channels or cooling lines in particularly simple manner with at least one part of a wall in one piece with the laying-pipe segment and to integrate the cooling channels or cooling lines appropriately. In the additive manufacturing, the cooling channels or cooling lines could produce a material-free region for formation of a cooling channel or of a cooling line directly during the manufacturing itself, for example by leaving out material in the corresponding layer.

It will be understood that further walls or, for example, supply or discharge channels may be additionally provided if this seems advantageous.

In the present connection, a “cooling channel” may preferably be designated as any kind of channel through which or along which a coolant is passed and which therefore ensures the appropriate cooling of the laying-pipe segment or of another component. Thus the main cooling issues from the cooling channel or from its wall. In particular, a channel does not have to be closed, as long as coolant is able to channel in sufficient quantity.

In contrast, by cooling line in the present connection, a closed line may be preferably understood through which the coolant flows and is passed into the region where the actual cooling is to take place. It will be understood that the cooling line in itself may also serve as a chilling line, for example for the laying-pipe segment or another component, and even cool the corresponding surroundings of the cooling line.

It is of advantage when the cooling channel is disposed within a wall of the laying-pipe segment. In this way, the cooling channel may be provided directly with the laying pipe, which is easy to integrate by the additive manufacturing. In addition, the arrangement of the cooling channel within a wall of the laying-pipe segment offers a particularly effective cooling of the laying-pipe segment, since the cooling channel, which is intended to cool the laying-pipe segment, is situated directly within the spontaneously heating workpiece. The cooling therefore takes place in maximum proximity to the part to be cooled, so that in this way the heat transfer for cooling of the laying-pipe segment is particularly good. Moreover, a construction of a laying-pipe segment with integrated cooling channel having a particularly space-saving configuration is beneficial, since the cooling channel not only is formed in one piece with the laying-pipe segment, for example outside the wall, but it is possible that the dimensioning of the laying-pipe segment will not be changed by the fact that a cooling channel is disposed within the wall of the laying-pipe segment.

In order to achieve these same advantages, the cooling line may also be disposed within a wall of the laying-pipe segment. It will be understood that, during passage of a coolant through the cooling line to a particular point of the apparatus, the cooling line itself also has a cooling effect already on the laying-pipe segment, so that not only can coolant be passed further through the cooling line, but also it cools the laying-pipe segment directly. This additional cooling effect by the cooling line on the laying-pipe segment is intensified by an arrangement of the cooling line within a wall of the laying-pipe segment, since the cooling line is situated directly within a wall of the laying-pipe segment, in other words of the workpiece that is being spontaneously heated and is to be cooled.

In order to permit an individual configuration of wearing regions of a laying pipe or a simple adaptation even to a very complex course of the laying-pipe axis, a laying-pipe segment, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment, may be characterized in that the laying-pipe segment has at least one or more contact points formed in one piece with the laying-pipe segment and projecting beyond the laying-pipe segment cross section for holding on a holder.

If the laying-pipe segment or the laying pipe is to be held by a laying-pipe holder, for example, possible holder elements may hold the laying-pipe segment in position.

The contact points of the respective laying-pipe segment or of the laying pipe for such a holding may be constructed here in various ways, depending on type of the desired holder elements. Thus, for example, perforated tabs, in which screws are introduced, may be provided on the laying-pipe segment in order to permit a positioning. Contact faces, which prevent a sliding or the like, may also be formed in this way in or on the laying-pipe segment. The configuration of these may be very diverse and they nevertheless can be provided and implemented as simply as possible with the additive manufacturing. Whereas otherwise a holder would have to provide appropriate means to hold the laying-pipe segment, it is possible in this way to provide appropriate contact points for holding on a holder by the additive manufacturing directly with the laying-pipe segment, so that no external aids, such as brackets, collars or the like, are necessary for provision of an appropriate contact point.

It is advantageous when the contact point represents a first component of a multi-component fastening system or when at least one or more of the contact points respectively represent a first component of a multi-component fastening system. The first component may serve here as the first component of the fastening system with a holder, such as a laying-pipe holder, for example, which comprises the corresponding mating piece of the fastening system, for example a holder element, then as a second component. Hereby a simplest possible fastening of the laying pipe on a holder, such as a laying-pipe holder, can take place, since only the first component has to be connected with the corresponding mating piece of the laying-pipe holder. Consequently, a simplest possible replacement is possible for the laying pipe, which is exposed to a high wear and has to be replaced from time to time, wherein this replacement process may be correspondingly simplified. It is conceivable to equip the fastening pipe if applicable with yet a further third component, such as, for example, a screw, a clamp, a shackle, a rivet, etc., which connects the holder element and the contact point or the first and the second components with one another.

In order to permit a best possible hold of the contact points with small material outlay, the contact point or at least one of the contact points may be a holding arm. In addition, this ensures an easy fastening with a holder. It will be understood that a holding arm may be formed here in the most diverse manner, but has the character of an arm, in other words an elongated and narrow structure, since the material savings here are as high as possible with nevertheless good hold.

Cumulatively or alternatively to this, in order to achieve these same advantages, the contact point may also be a plate or tab.

Alternatively or cumulatively to this, a laying-pipe segment, as part of a laying pipe for depositing a workpiece guided through the laying-pipe segment, with a laying-pipe segment length, with a laying-pipe segment axis deviating along the laying-pipe segment length from a straight line, with an outside diameter and an inside diameter, by the difference of which a wall thickness is determined, as well as with a laying-pipe segment cross section formed along the laying-pipe segment axis, wherein the wall thickness is determined at a particular height of the laying-pipe segment axis of the laying-pipe segment, may also be characterized in that the laying-pipe segment is formed in one piece with at least one air-guiding surface or with several air-guiding surfaces, in order to permit an individual configuration of wearing regions of a laying pipe or a simple adaptation even on a very complex course of the laying-pipe axis.

In the present connection, preferably any surface that guides the air in desired manner may be understood as an “air-guiding surface”. It is conceivable here that the air-guiding surface guides the air in exactly defined aerodynamic manner or guides it at least approximately in a particular manner, so that, in the present connection, this air-guiding surface may be purposefully used to guide the air in a particular direction.

A guiding of the air by the air-guiding surfaces could happen on the one hand by the fact that a stationary air-guiding surface experiences an air stream and then guides this appropriately over the air-guiding surface. On the other hand, the air-guiding surface may be in the moving state, such as, for example, as part of a rotating body, so that the moving air-guiding surface guides the air stream impinging on the air-guiding surface in desired form. It will be understood that the aerodynamic sequences are in reality extremely complex and very probably a combination of the processes described above takes place, so that air-guiding surfaces deflect the air streams impinging on the air-guiding surfaces due to their own motion as well as flowing through them as a whole, wherein the air may be guided through the air-guiding surface into particular zones. For this purpose, the air-guiding surface may be appropriately adapted both in its shape and in its alignment. By using an additive manufacturing method, it is possible to configure an air-guiding surface individually in particularly simple manner, in order to adapt the air-guiding surface according to the aerodynamic requirements.

In this way, an improved air cooling of the laying-pipe segment may be achieved by the air-guiding surfaces. The rotation or movement of the laying pipe may be utilized to cool the laying pipe in specific manner by air. With the rotation or the movement of the laying pipe, the air-guiding surface is also rotated or also moved correspondingly. The air-guiding surfaces may be formed in such a way as to guide air along the pipe, so that the air stream air-cools the laying pipe. The air-guiding surface would be appropriately formed here such that it guides the air along the pipe or onto the pipe. It is also conceivable for an air circulation within the laying pipe formed in spiral shape to be generated or intensified when air-guiding surfaces are appropriately configured. Such an air circulation has a cooling effect on the laying pipe itself as well as on its surroundings.

In addition, an air cooling provided by appropriate air-guiding surfaces has the advantage that the laying pipe, especially in addition to other cooling methods, is provided by means that are provided directly by the laying-pipe segment as a result of appropriate one-piece manufacturing, preferably by means of additive manufacturing, and thus no external means are necessary for air cooling. The air cooling by the air-guiding surfaces may therefore take place during the entire time of use of the laying pipe, especially when this is moving or rotating, without simultaneously generating additional expense, occupying additional space for air-cooling systems or without generating additional costs, beyond the pure material costs that arise for the air-guiding surfaces during the manufacturing.

Preferably, the contact point is or the contact points are manufactured additively, since the advantages of an additive manufacturing, as already explained in the introduction, are accompanied by the fact that, for example, complex structures can be configured in the simplest possible manner with the laying-pipe segment and can already be integrated during the manufacturing.

In order to achieve these same advantages, the air-guiding surface or the air-guiding surfaces may also be manufactured additively. Depending on how the air stream or how the air is to be guided by the air-guiding surfaces, especially for cooling, the structures of the air-guiding surfaces may turn out to be extremely complex, so that they can be manufactured only with great expense by conventional manufacturing methods. The additive manufacturing methods are characterized precisely in that even complex structures can be manufactured in the simplest possible manner. At the same time, the additive manufacturing methods are able to manufacture these complex structures directly in one piece with the laying-pipe segment, so that even complex structures, for example in the form of the air-guiding surfaces or of the contact points, may be manufactured and provided directly with the laying-pipe segment.

Preferably, the laying-pipe segment forms the laying pipe together with at least one further laying-pipe segment. If only one of the laying-pipe segments that form the laying pipe must be replaced, for example because of wear, then only that individual laying-pipe segment has to be replaced due to wear.

On the other hand, it may be particularly advantageous for the laying-pipe segment alone to form the laying pipe. In this case, it would not be an individual laying-pipe segment that has to be removed and appropriately reinserted for replacement of the laying-pipe segment, but instead the replacement of a laying-pipe segment also directly ensures the replacement of the entire laying pipe. Thus a simple and rapid replacement of the laying pipe may be achieved. Since the structure of a laying pipe is spiral-shaped, for example, and thus extremely complex, the manufacture of a laying-pipe segment that alone forms a laying pipe has been presented in the prior art as extremely expensive. By the additive manufacturing methods, however, even the complex structure of a laying pipe can be manufactured relatively simply, so that it is possible to manufacture a laying-pipe segment that alone forms the laying pipe. Since individual regions within a laying pipe experience, for example, a higher wear than other regions, theoretically the laying pipe would already have to be replaced completely if a small region of the laying-pipe segment is worn. However, since the laying-pipe segment is manufactured additively, it can be formed or reinforced directly during manufacturing in the correspondingly highly loaded regions, to the effect that a replacement of the laying-pipe segment and thus of the entire laying pipe becomes necessary only much later than would be the case for a conventional laying-pipe segment, so that the simple and rapid replacement of the entire laying pipe formed from one laying-pipe segment alone is worthwhile.

Beyond this, the formation of the laying pipe by one laying-pipe segment alone offers the advantage that, depending on area of application, a laying pipe can be manufactured individually. For example, various surrounding conditions exist for different machines at different sites, so that a laying-pipe segment that alone forms the laying pipe may then be manufactured additively in a manner corresponding to the existing spatial conditions. Even the individual configuration of a laying pipe for which particular material properties are demanded proves to be relatively simple, since it is possible in one additive manufacturing step to manufacture only one laying-pipe segment for the laying pipe. Since additive manufacturing methods prove to be particularly economic for small numbers of pieces in particular, even an individual manufacture of one laying pipe by additive manufacturing methods is particularly advantageous.

In order to achieve a high wear resistance and temperature resistance of the laying-pipe segment, the laying-pipe segment may preferably be manufactured from hard metal.

In the present connection, preferably a metal matrix composite material, in which hard substances that exist as small particles held together by a matrix of metal may be understood as a hard metal. Thereby hard metals are somewhat less hard than the pure hard substances but are significantly tougher. On the other hand, they are harder than pure metals, alloys and hardened steel, but in return they are more sensitive to fracture. On the basis of their composition, hard metals may preferably be classified into three groups: tungsten carbide-cobalt hard metals (WC—Co), hard metals for steel machining (WC—(Ti, Ta, Nb)C—Co) and cermets. Mostly tungsten carbide (WC) is used as hard substance, but these may also be titanium carbide (TiC), titanium nitride (TiN), tantalum carbide or vanadium carbide. Cobalt or otherwise mainly nickel or mixtures of the two are used as binder for the matrix of WC types. Most WC—Co hard metals consist of 73-97% tungsten carbide and 3-27% cobalt. However, special types are also known in which nickel is used as the binder. Thereby the hard metal has a particularly high corrosion resistance and in general is not magnetizable. Furthermore, the possibility also exists of resorting to particularly tough binders of an iron-nickel-cobalt mixture.

Hard metals therefore have precisely the properties that a laying-pipe segment should have for the intended purpose of use in order to optimize the properties essential for a wearing part.

For the production of hard metals, in principle the following steps of the hard-metal production can be distinguished: mixing/grinding/granulate manufacture, forming and sintering. These are followed by finish-machining or coating, depending on application and workpiece. Since the last step of the actual production consists of the sintering, the process can be integrated particularly well into the appropriate additive manufacturing method, since the actual mixing and the granulate manufacturing can take place beforehand and even the sintering process can take place during the additive manufacturing, so that hard metals can be manufactured additively.

In the present connection, it is possible in particular here to change or vary the laying-pipe segment properties by the local variation of the different proportions of matrix and hard substances as well as the variation of the actual materials for the matrix and/or the hard substances. In particular, the material properties but also other laying-pipe properties may be adapted very precisely and with flowing or almost flowing transitions, so that even the danger of crack formations and the like, for example due to abrupt changes of the laying-pipe segment properties, may be minimized.

In order to permit an individual configuration and a rapid replacement of wearing regions of a laying pipe or of a laying-pipe holder, a laying-pipe holder for holding a laying pipe with functional elements joined undetachably to one another, wherein the functional elements are formed as rotatably held bearing bodies, as solids of revolution and/or as stationary racks, as well as formed with holder elements, can be characterized in that functional elements, formed in one piece, of the laying-pipe holder are produced by means of an additive manufacturing method.

In the present connection, the additive manufacturing methods describe, as already explained in the foregoing, preferably a group of manufacturing methods that build up three-dimensional component parts in an automated, layering process from a shapeless or shape-neutral material. The term “additive manufacturing” underscores two important features of the methods: The production of component parts by the addition of material and the suitability as an industrial manufacturing method.

In the present connection, a “bearing body” may preferably be used as a bearing for a solid of revolution, so that the solid of revolution is intrinsically able to rotate, wherein the bearing body serves as the bearing for this rotation, so that the bearing body in itself preferably does not also rotate. The arrangement of a bearing body and a solid of revolution is advantageously combined with a stationary rack, which serves as a solid support or as a fixed frame for the overall construction of the laying-pipe holder and permits a secure connection with the surroundings. This may be understood as a secure connection, for example with the floor or else even with another preferably fixed machine part.

The holder elements of the laying-pipe holder may form here an appropriate fitting mating piece for the contact points of a laying-pipe segment or of a laying pipe. The holder elements of the laying-pipe holder on the one hand and the contact points of the laying pipe or of the laying-pipe segment on the other hand may be matched in particular to one another, so that the holder elements can be connected particularly simply with the contact points of the holding-pipe segment. In this way, the laying pipe can be inserted particularly simply into the laying-pipe holder in order then to be held by the laying-pipe holder. Since the laying pipe is a wearing part and must be regularly changed, a good as well as simple holding by means of the holder elements and the contact points proves to be particularly advantageous.

It is of advantage when the holder elements are likewise manufactured additively. By the additive manufacturing, the holder elements may be manufactured in particularly simple manner, wherein they may also be individually configured particularly simply. The holder elements may be formed in completely different manners depending on requirements and surrounding conditions. In particular, the adaptation of the holder elements to the corresponding mating pieces, such as, for example, the contact points of the laying pipe, proves particularly simple by an additive manufacturing process.

The additive manufacturing is particularly of advantage here, in order to form this in simple manner such that is complementary to the associated contact points of the laying pipe or of the laying-pipe segment. In particular, the functional elements or the holder elements may be matched in this way by manufacturing technology on the one hand to the complex course of the laying pipe or of the laying-pipe segment on the one hand and to a very simple course of the bearing body or solid of revolution of the laying-pipe holder on the other hand.

Advantageously, the holder element represents a second component of a multi-component fastening system. Thus the holder element forms the second component of the fastening system with the laying-pipe, which comprises the corresponding mating piece as the first component, for example in the form of the contact points explained in the foregoing. Hereby a simplest possible fastening of the laying pipe on the laying-pipe holder is possible. Even a relatively easy-to-handle connection, possibly with a third component, such as, for example, a screw, a clamp, a shackle, a rivet., etc., which connects the holder elements and the contact points with one another, may then be implemented structurally simply.

It is of advantage when the holder element has a cross-sectional face deviating from a plane. A cross-sectional face that deviates from a plane usually means a more complex structure, which may however ensure a better hold between laying-pipe holder and laying pipe. However, such more complex structures are offered precisely in the manufacturing with an additive manufacturing method, since more complex structures can be manufactured in particularly simple manner here, so that the advantages of the additive manufacturing methods may be utilized here. In particular, a conforming to a pipe-like structure, a vibration-resistant construction and/or a multiple functionality may be achieved, for example by the inclusion of line parts, additional holders or air-guiding surfaces in the holder elements.

In order to permit a simple replacement of the wearing regions, the holder element may be connected in one piece with a central body of the laying-pipe holder. Thus, if a replacement is needed, only the central body has to be replaced and, for insertion of a new central body, the holder elements are also provided directly, so that these may be manufactured at the same time and also provided at the same time in simplest possible manner.

In order to permit an individual configuration of wearing regions of a laying pipe and of a laying-pipe holder for different surrounding conditions or a simple adaptation even to a very complex course of the laying-pipe segment axis, a laying-pipe holder for holding a laying pipe with rack parts joined undetachably to one another, wherein the rack parts are formed as rotatably held bearing bodies, as solids of revolution and/or as stationary racks, as well as formed with holder elements, may be characterized in that at least one rack part comprises a coolant channel, wherein the rack part containing the coolant channel forms a functional element and the latter is formed in one piece. In this way a coolant channel may already be provided particularly simply by the rack part, so that no separate apparatus is needed for provision of a coolant channel. Thus a space-saving construction of the laying-pipe holder may be favored.

Cumulatively or alternatively to this, in order to achieve these same advantages, a laying-pipe holder for holding a laying pipe with rack parts joined undetachably to one another, wherein the rack parts are formed as rotatably held bearing bodies, as solids of revolution and/or as stationary racks, as well as formed with holder elements, may also be characterized in that at least one rack part comprises a coolant channel, wherein the rack part containing the holder element forms a functional element and the functional element is formed in one piece. Hereby it is possible with a suitable configuration to ensure in particular a simple assembly, if the coolant channel can be continued directly into the laying-pipe segment or into the laying pipe when the laying pipe is brought into its position for which it is intended on the laying-pipe holder.

Cumulatively or alternatively to this, a laying-pipe holder for holding a laying pipe with rack parts joined undetachably to one another, wherein the rack parts are formed as rotatably held bearing bodies, as solids of revolution and/or as stationary racks, as well as formed with holder elements, may be characterized in that at least one rack part comprises a coolant line, wherein the rack part containing the coolant line forms a functional element and the functional element is formed in one piece. The additive manufacturing makes it possible even here to form a coolant line in one piece with a rack part in simplest possible manner, whereby the coolant line may then also be provided directly with the rack part, without the need for additional separate means for conveying a coolant.

Beyond this, cumulatively or alternatively to this, a laying-pipe holder for holding a laying pipe with rack parts joined undetachably to one another, wherein the rack parts are formed as rotatably held bearing bodies, as solids of revolution and/or as stationary racks, as well as formed with holder elements, may be characterized in that at least one rack part comprises a coolant line, wherein the rack part containing the holder element forms a functional element and the latter is formed in one piece. Thus holder elements may be provided directly with the rack part in the simplest possible way. By the additive manufacturing methods, such a construction is also particularly simple to ensure and may, in suitable configuration, also lead in particular to a direct linking to a coolant channel or to a coolant line of the laying pipe or of the corresponding laying-pipe segment, which is being held by the corresponding holder element.

Preferably, the additive manufacturing method is a selective laser-sintering method.

In the present connection, the “selective laser-sintering method” may also be understood as laser sintering for short. This is abbreviated in the technical jargon as SLS (selective laser sintering) and preferably describes a powder-bed-based additive manufacturing method, in which the powder layers are melted with a laser beam to correspond to the current component-part layer. The starting material for laser sintering is present in the form of powder or granulate, such as is also the case for hard metals, for example. For the method, construction space and granulate should be preheated to a material-dependent temperature just under the melting point. The melting of the powder/granulate takes place by a laser or electron beam. During cooling, the molten particles bind together to a solid object. The support function is taken over here by the excess powder/granulate. Depending on intensity of the beam, it is possible to generate both porous component parts and also component parts that are up to completely 100% dense. In principle, the selective laser-sintering method may be used both with metals and also with plastics.

For the selective laser-sintering method, construction space and powder/granulate should be brought to a temperature just under the melting point. Thus the energy source of the laser needs to supply only a little more energy for melting. If a layer has been finish-sintered, the construction platform is lowered by one layer thickness and a new powder/granulate is applied. In the present connection, the laser sintering may be distinguished here into the selective sintering, when melting takes place only superficially, and into beam melting or selective laser sintering, when the particles are completely melted. Since even in the production of hard metals, the starting material exists in the form of powder or granulate and must also be sintered, the selective laser-sintering method is also offered for, among other purposes, hard metals, which have particularly advantageous properties for the use of a laying pipe or of a laying-pipe holder.

The advantages explained in the foregoing can also be implemented, as already suggested, by an arrangement of an appropriate laying-pipe holder and a corresponding laying pipe of at least one laying-pipe segment, in that the laying-pipe holder is connected with the laying pipe via holder elements as the first components of a two-component fastening system and via contact elements or contact faces as the second components of the two-component fastening system.

In particular, the laying-pipe holder may be combined with a cooling unit to an arrangement in which the cooling unit comprises coolant supply lines for supplying coolant in the coolant channel or in the coolant line, so that the laying-pipe holder may be supplied appropriately with coolant. Preferably, the coolant may then be conveyed in a loop, thus ensuring a cooling of the laying pipe or of the laying-pipe segment.

It will be understood that the features of the solutions described in the foregoing or in the claims may also be combined if necessary in order to be able to implement the advantages correspondingly cumulatively.

### BRIEF DESCRIPTION OF THE DRAWINGS

Further advantages, objectives and properties of the present invention will be explained on the basis of the following description of exemplary embodiments, which are also illustrated in particular in the accompanying drawing. In the drawings:

FIG. 1 shows a schematic diagram of a first laying pipe in a representation from below;

FIG. 2 shows a schematic diagram of the first laying pipe according to FIG. 1 in a perspective representation;

FIG. 3 shows a schematic diagram of the first laying pipe according to FIGS. 1 and 2 in a side view;

FIG. 4 shows a schematic diagram of a second laying pipe in a perspective representation;

FIG. 5 shows a schematic diagram of the third laying pipe in a side view;

FIG. 6 shows a cross section through a laying-pipe segment perpendicular to the laying-pipe segment axis in schematic representation;

FIG. 7 shows a cross section through a laying-pipe segment perpendicular to the laying-pipe segment axis in schematic representation with varying wall thickness;

FIG. 8 shows a cross section through a laying-pipe segment perpendicular to the laying-pipe segment axis in schematic representation with varying material properties;

FIG. 9 shows a cross section through an arrangement of a laying-pipe holder and a laying pipe in schematic cross section;

FIG. 10 shows a depositing device with the arrangement according to FIG. 9;

FIG. 11 shows the arrangement according to FIG. 9 in perspective view from obliquely underneath; and

FIG. 12 shows a cross section through a holder and a laying pipe or a laying-pipe segment perpendicular to the laying-pipe segment axis in schematic representation;

FIG. 13 shows a cross section through a laying pipe or a laying-pipe segment formed in one piece with a holder perpendicular to the laying-pipe segment axis in schematic representation;

FIG. 14 shows a cross section through a laying pipe or a laying-pipe segment formed in one piece with a holder perpendicular to the laying-pipe segment axis with an air-guiding surface in schematic representation; and

FIG. 15 shows an arrangement according to FIG. 14 in a side view in schematic representation.

### DETAILED DESCRIPTION OF PREFERRED EMBODIMENTS

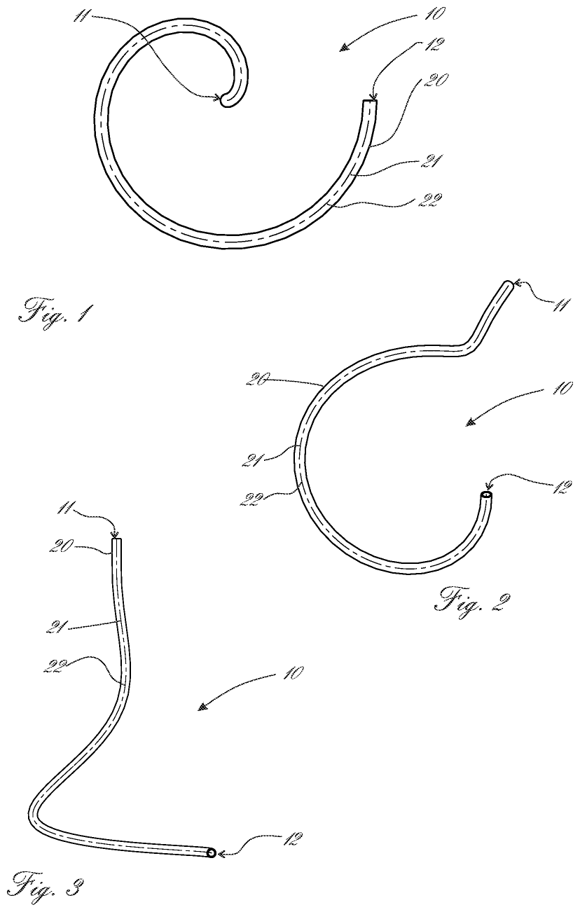

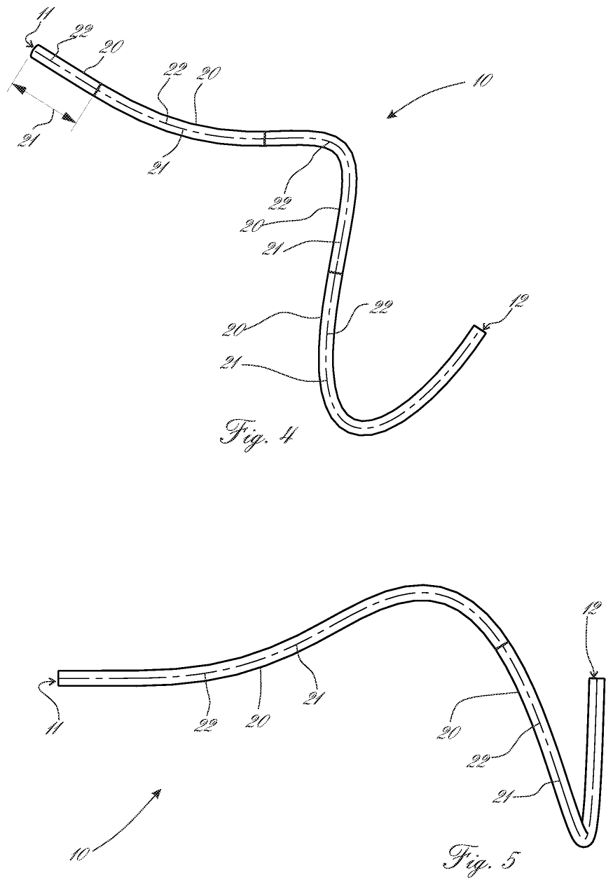

In a first exemplary embodiment according to FIGS. 1 to 3, a laying pipe 10 is formed entirely from one laying-pipe segment 20, wherein FIGS. 1 to 3 respectively show different views of the laying pipe 10.

The laying-pipe segment 20 has a laying-pipe segment length 21, which is defined along a laying-pipe segment axis 22 deviating from a straight line, wherein both the laying-pipe segment length 21 and the laying-pipe segment axis 22 extend from a laying-pipe inlet 11 to a laying-pipe outlet 12.

In the present exemplary embodiment, the laying pipe 10 is configured in a roughly spiral-shaped form. By this form, the laying pipe 10 is able to lay a workpiece 80 guided lengthwise through the laying pipe 10 in particularly simple manner, in that the workpiece is introduced along the laying-pipe segment axis 22 into the laying pipe 10 and, due to the spiral-shaped configuration of the laying pipe 10, can be deposited horizontally. By a rotation of the laying pipe 10, a workpiece is then deposited horizontally in circular manner.

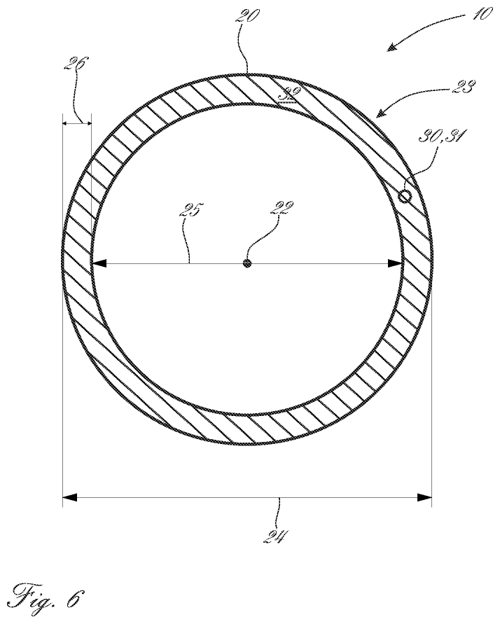

The laying pipe 10 is similarly configured in the second and third exemplary embodiments according to FIGS. 4 and 5. In these exemplary embodiments, however, the laying pipe 10 is formed not from a single laying-pipe segment 20, but instead four or two laying-pipe segments 20 together form the laying pipe 10.

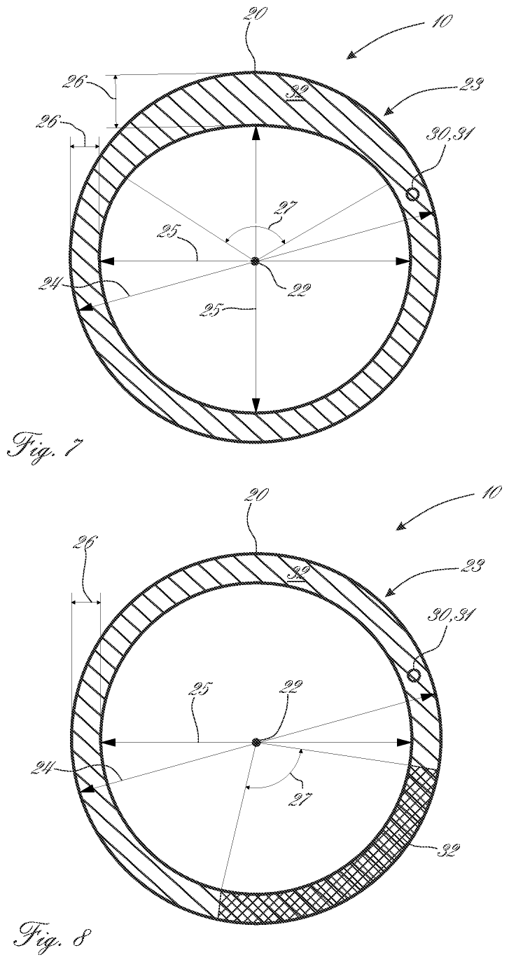

Beyond this, the laying-pipe segments 20 of the exemplary embodiments according to FIGS. 1 to 6 respectively have, as is then schematically illustrated in FIG. 6, an outside diameter 24 and an inside diameter 25, by the difference of which a wall thickness 26 is determined. In addition, the laying pipe segments 10 respectively have, along the laying-pipe segment axis 22, a laying-pipe segment cross section 23, wherein the wall thickness 26 is determined at a particular height of the laying-pipe segment axis 22 of the laying-pipe segment 20. The wall thickness 26 here indicates the thickness of the wall 32 of the laying-pipe segment 20.

In addition, in the exemplary embodiments according to FIGS. 1 to 6, a cooling channel 30 or a cooling line 31 is disposed within the wall 32. It will be understood that, in deviating embodiments, several of such cooling channels 30 or cooling lines 31 may be provided or such features may be omitted.

In addition, the laying-pipe segments 20 of the exemplary embodiments according to FIGS. 1 to 6 are produced by means of an additive manufacturing method. The additive manufacturing methods make it possible here for the laying-pipe segments 20 to have a gradient of the laying-pipe segment properties along the laying-pipe segment axis 22, which is not visible from the figures of the present exemplary embodiments. Thus regions of a laying-pipe segment 20, for example, have a higher hardness than other regions of the laying-pipe segment 20. This can happen in an additive manufacturing method, for example by the respective choice of the powder mixtures used to build up the respective laying-pipe segments 20 at the corresponding positions. It is also conceivable for the laying-pipe segment 20 to have this gradient of the laying-pipe segment properties along the laying-pipe segment cross section 23. The laying-pipe segments 20 may also have a gradient of further laying-pipe segment properties, such as, for example, of the wall thickness, so that a laying-pipe segment 20 has different wall thicknesses 26 along the laying-pipe segment axis 22 and/or along the laying-pipe segment cross section 23 or along an angle of rotation 27. In addition, the different laying-pipe segment properties within a laying-pipe segment 20 may be formed as flowing material progressions, so that no abrupt difference but instead a flowing transition exists between the individual laying-pipe segment properties. One such can be achieved particularly simply by the production by means of an additive manufacturing method.

As the exemplary embodiment according to FIG. 6 shows, the laying-pipe segment 20 is formed in one piece with at least one part of a wall 32 of a cooling channel 30 or of a cooling line 31, whereby a particularly effective cooling can take place within the wall 32 of the laying-pipe segment 20.

In a further exemplary embodiment according to FIG. 7, a cooling line 31 formed as cooling channel 30 is disposed within the wall 32 of a laying-pipe segment 20. The cooling line 31 may be integrated particularly simply within the wall 32 by means of an additive manufacturing method.

As an example, a cooling fluid may then be passed through the cooling line 31 or along a cooling channel 30, so that the cooling fluid flows through the cooling line 31 and thus also through the wall 32 of the laying-pipe segment. In this way, the laying-pipe segment 20 may be cooled by the cooling fluid in the cooling line. A workpiece, which is guided in the laying-pipe segment 20, on the one hand generates heat of friction and, however, as a consequence of the manufacturing process, is also able to carry heat in itself, which it releases to the laying pipe 10. This is undesirable, however, because it could have the consequence, for example, of deformations and changes of the material properties of the laying-pipe segment 20.

The arrangement of the cooling line within the wall 32 of the laying-pipe segment 20 represents a particularly effective cooling method here, since the cooling fluid is then directly in contact with the object to be cooled. Moreover, no external apparatuses are needed here any longer for cooling.

It will be understood that the cooling channel 30 does not absolutely have to be formed in closed manner.

In the exemplary embodiment of FIG. 7, the wall thickness 26 of the laying pipe segment 20 varies along an angle of rotation 27, wherein the inside diameter 25 of the laying-pipe segment 20 also varies along the angle of rotation 27. At the same time, an outside diameter 24 of the laying-pipe segment 20 remains constant over the angle of rotation 27 or over an entire laying-pipe segment cross section 23. It will be understood that the inside diameter 25 could also be constant along the angle of rotation 27 and only the outside diameter 24 varies along the angle of rotation 27, whereby likewise the wall thickness 26 of the laying-pipe segment 20 would also vary along the angle of rotation. A configuration is also conceivable in which both the inside diameter 25 and the outside diameter 24 vary along the angle of rotation 27, and thus also the wall thickness 26 of the laying-pipe segment 20 varies along the angle of rotation.

Such a variation of the wall thickness 26 makes it possible in particular to counteract a wear at particular places.

Cumulatively or alternatively to the configurations mentioned in the foregoing, the variations or the constancy of the outside diameter 24, of the inside diameter 25 or of the wall thickness 26 may also take place along a laying-pipe segment axis 22 or along a laying-pipe segment cross section 23 and not just only along the angle of rotation 27.

Thus the possibility exists of configuring the laying-pipe segment 20 extremely individually, wherein the transitions, as a consequence of the manufacturing method, may be formed extremely flowingly.

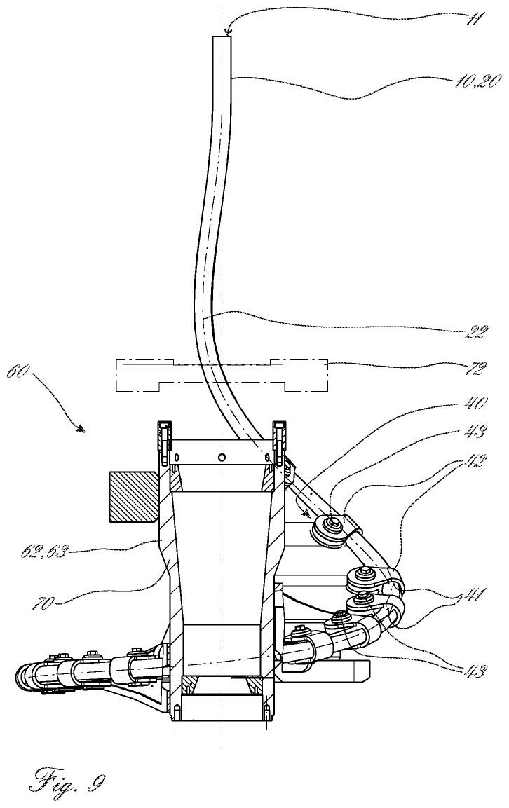

In a further exemplary embodiment illustrated in FIG. 8, a laying-pipe segment is shown that substantially is as in the exemplary embodiment according to FIG. 6, wherein the material properties of the laying-pipe segment 20 in the present exemplary embodiment vary along an angle of rotation 27. Material properties may be, for example, modulus of elasticity, density, hardness, compressive strength or flexural strength or even the material composition, especially the hardness and density of the hard substances. These are partly adapted in one region of the laying-pipe segment 20, in order to reinforce the affected region in this way against the high load or against the serious wear due to a workpiece 80 in the said region.

In addition, in the embodiment presented according to FIG. 8, the laying-pipe segment 20 is formed with a relatively abrupt material progression. It is also conceivable, however, for the laying-pipe segment 20 to be formed with a flowing material progression, wherein this is to be understood as a gradient of the material progression within the laying-pipe segment 20, which likewise may proceed both in the laying-pipe segment cross section 23 and along the laying-pipe segment length 21.

The production of the laying-pipe segment 20 by means of an additive manufacturing method proves particularly advantageous for configuring a region or particular regions of the laying-pipe segment 20 individually in such a way that the material properties of the laying-pipe segment 20 vary along the angle of rotation 27. These are capable of configuring regions of a workpiece containing various materials and thus also having various material properties, wherein the workpiece in itself is nevertheless manufactured in one piece. Thus, for example, it is not necessary for several laying-pipe segments 20 having different material properties to be assembled as one laying pipe 10, in order then to generate, in the region of the laying-pipe segment 20 having particular properties, such varying material properties within one laying pipe 10.

Cumulatively or alternatively to the embodiments described in the foregoing, it is also conceivable for the material properties of the laying-pipe segment 20 to vary along the laying-pipe segment axis 22 or along the laying-pipe segment cross section 23. Thus the material properties of the laying-pipe segment 20 are able to vary in all three dimensions and the laying-pipe segment 20 may be configured in any desired manner with respect to the material properties. This is possible particularly simply by the production by means of an additive manufacturing method.

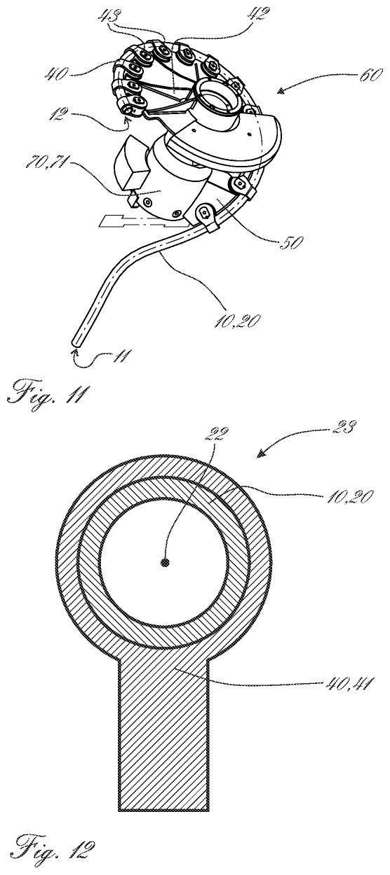

In a further exemplary embodiment according to FIGS. 9 to 12, a laying pipe 10, which is formed entirely from one laying-pipe segment 20, is disposed in a laying-pipe holder 60. The laying pipe 10 formed in spiral shape, is held here by a holder 40 on the laying-pipe holder 60, wherein the holder 40 comprises a holder element 42, which holds the laying pipe 10 at contact points 41.

It will be understood that the laying pipes according to FIGS. 1 to 8 may be correspondingly disposed and provided with contact points 41.

In this respect, the contact points 41 form first components and the holder elements 42 second components of a multi-component fastening system. By holding screws 43 as further components, the first two components are connected with one another and the laying pipe 10 is fastened on the holder 40.

Functional elements, which are connected undetachably with one another and in the present exemplary embodiment are formed as rotatably held bearing bodies 62, as the central body 63 and also as the rack part 70, and specifically as the solid of revolution 71, which represents the corresponding rack part 70, form the center of the laying-pipe holder 60, wherein a stationary rack part 72, on which the solid of revolution 71 is mounted, is also to be counted among the rack parts 70.

In addition, air-guiding surfaces 50, which guide the air appropriately and may likewise represent functional parts, are formed on the laying-pipe holder 60, whereby, for example, a possibly additional air cooling of the laying pipe 10 may take place.

In addition, the functional elements of the present exemplary embodiment of the laying-pipe holder 60 are produced by means of an additive manufacturing method, whereby an individual configuration and a faster replacement of wearing regions of a laying pipe 10 and of a laying-pipe holder 60 are ensured. The holder elements 42 are also manufactured additively.

In this way, the laying pipe 10 may be held operationally safely in particularly simple manner by the laying-pipe holder 60. In addition, the holder elements 42 have a cross-sectional face deviating from a plane, wherein the form of these holder elements 42 may be produced simply, however, by means of an additive manufacturing method.

Moreover, it is conceivable for the holder element 42 to be connected in one piece with a central body 63 of the laying-pipe holder 60.

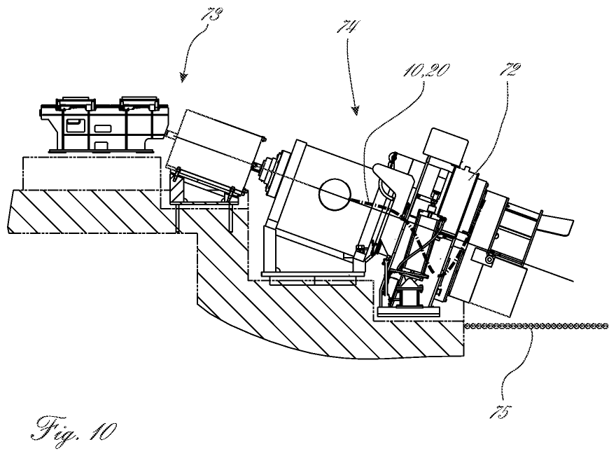

As is also illustrated in FIG. 10 of the present exemplary embodiment, the entire system comprises a driver 73, which is connected downstream from a winding laying head 74. The driver 73 displaces a workpiece to be deposited and drives it into the winding laying head 74. The winding laying head 74 comprises the stationary rack part 72.

The laying-pipe holder 60 with the central body 63 and the solid of revolution 71 is disposed within the stationary rack part 72. Thus the laying pipe 10 or the laying-pipe segment also extends within the winding laying head 74 and within the stationary rack part 72 (indicated by a dot-dash curve in FIG. 10). It will be understood that, in the arrangement illustrated in FIG. 10, it is possible to provide each laying pipe 10 or each laying-pipe segment 20 as well as each laying-pipe holder 60 or each solid of revolution 71 that are described in the present case.

After exiting the winding laying head 74, the workpiece is deposited horizontally on a moving deposition surface 75, wherein the moving deposition surface 75 is formed in the present exemplary embodiment as a rolling deposition surface. In this way, the deposited workpiece can be transported away. It will be understood that the moving deposition surface may be formed in any other manner, provided it is capable of displacing the deposited workpiece in appropriate manner. For example, a running conveyor belt or the like may be provided.

In a further exemplary embodiment according to FIG. 13, the laying-pipe segment 20 or the laying pipe 10 is formed in one piece with the contact point 41 as the first component of the holder 40. In this way, the laying pipe may be provided directly with the holder 40. During replacement of the laying pipe 10 or a laying-pipe segment 20, the contact points 41 are therefore also sometimes replaced. However, this may simplify the entire replacement process considerably because, for example, the laying pipe 10 would not have to be separated first from separate clamps and the new laying pipe 10 connected again with the separate clamps. This represents a greater effort than replacing the laying pipe 10 with the contact points 41 connected in one piece, wherein only the contact points 41 have to be fastened again to a rack, to the holder elements 42 or the like. Such a one-piece configuration can be implemented in particularly simple manner by additive manufacturing methods.

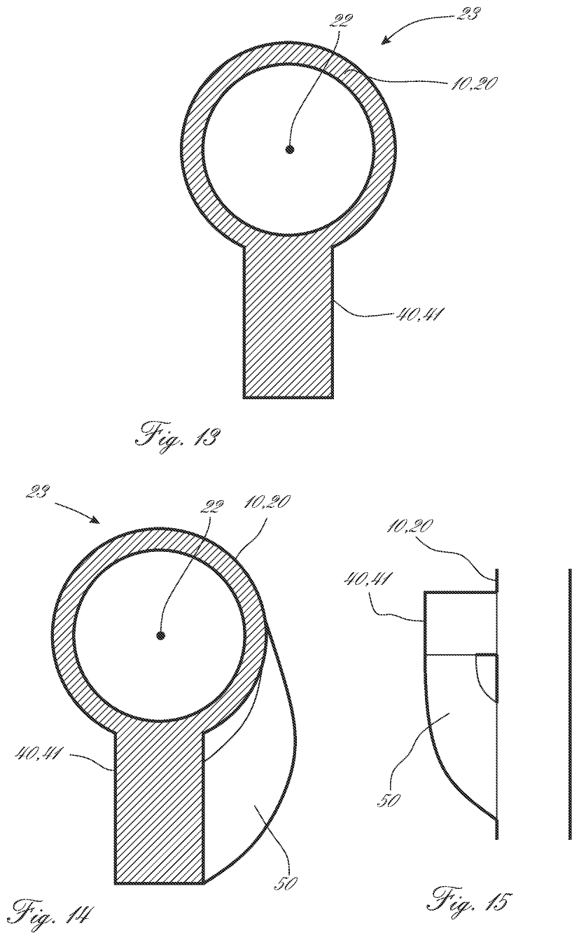

In a further exemplary embodiment according to FIGS. 14 and 15, basically a one-piece construction of the laying-pipe segment 20 with the holder element 42 according to the exemplary embodiment according to FIG. 13 is provided. In addition, the laying-pipe segment 20 or the laying pipe 10 is formed in one piece with a scoop-like air-guiding surface 50.

For example, air from the surroundings is guided over the air-guiding surface 50 by a rotary movement of the laying pipe 10, in order to deposit a corresponding workpiece. Thus the air can be guided in specific manner in one direction or into one region. In the present embodiment, the air-guiding surface 50 is formed in such a way that air is guided along the laying pipe 10 or along the laying-pipe segment 20 by the movement that the laying pipe 10 experiences. In this way, an air cooling for cooling the laying pipe 10 is generated. However, this air cooling is provided in particularly simple manner by the one-piece construction of the air-guiding surface 50 with the laying pipe 10, so that no external apparatus is needed any longer in order to generate an air cooling. In particular, the space savings may be of great importance, depending on surrounding conditions. In addition, except for the actual manufacturing, no further costs arise during the cooling.

The additive manufacturing makes it possible to manufacture the air-guiding surface in particularly simple manner in almost any desired configuration, so that entirely individual forms of the air-guiding surface are possible, depending on how ac-curately the air is to be guided for the correspondingly desired cooling.

Although only a few embodiments of the present invention have been shown and described, it is to be understood that many changes and modifications may be made thereunto without departing from the spirit and scope of the invention.

### LIST OF REFERENCE SYMBOLS

10 Laying pipe
11 Laying-pipe inlet
12 Laying-pipe outlet
20 Laying-pipe segment
21 Laying-pipe segment length
22 Laying-pipe segment axis
23 Laying-pipe segment cross section
24 Outside diameter
25 Inside diameter
26 Wall thickness
27 Angle of rotation
30 Cooling channel
31 Cooling line
32 Wall
40 Holder
41 Contact point
42 Holder element
43 Holding screws
50 air-guiding surface
60 Laying-pipe holder
62 Bearing body
63 Central body
70 Rack part
71 Solid of revolution
72 Stationary rack part
73 Driver
74 Winding laying head
75 Moving deposition surface

What is claimed is:

1. A laying-pipe segment configured to be part of a laying pipe for depositing a workpiece guided through the laying-pipe segment, the laying-pipe segment comprising:
(a) a laying-pipe segment length;
(b) a laying-pipe segment axis deviating) from a straight line along the laying-pipe segment length;
(c) an outside diameter;
(d) an inside diameter;
(e) a wall thickness determined by a difference between the inside diameter and the outside diameter; and
(f) a laying-pipe segment cross section formed along the laying-pipe segment axis;
wherein the wall thickness is determined at a selected height of the laying-pipe segment axis of the laying-pipe segment; and
wherein the laying-pipe segment is produced using an additive manufacturing method and forms a gradient of laying-pipe segment properties with flowing material progressions along at least one of the laying-pipe segment axis, the laying-pipe cross section, and an angle of rotation.

2. The laying-pipe segment according to claim 1, wherein the wall thickness of the laying-pipe segment varies along at least one of the laying-pipe segment axis, the laying-pipe segment cross section, and the angle of rotation.

3. The laying-pipe segment according to claim 1, wherein material properties of the laying-pipe segment vary along at least one of the laying-pipe segment axis, the laying-pipe segment cross section, and the angle of rotation.

4. The laying-pipe segment according to claim 1, wherein the laying-pipe segment is formed in one piece with at least one part of a cooling channel wall of a cooling channel or of a cooling line wall of a cooling line.

5. The laying-pipe segment according to claim 4, wherein the cooling channel or the cooling line is disposed within a wall of the laying-pipe segment.

6. The laying-pipe segment according to claim 1,
wherein the laying-pipe segment has at least one contact point formed in one piece with the laying-pipe segment and projecting beyond the laying-pipe segment cross section for holding on a holder; or
wherein the laying-pipe segment is formed in one piece with at least one air-guiding surface; or
wherein the laying-pipe segment has at least one contact point formed in one piece with the laying-pipe segment and projecting beyond the laying-pipe segment cross section for holding on a holder and is formed in one piece with at least one air-guiding surface.

7. The laying-pipe segment according to claim 6, wherein the at least one contact point represents a first component of a multi-component fastening system.

8. The laying-pipe segment according to claim 6, wherein the at least one contact point, the at least one air-guiding surface, or the at least one contact point and the at least one air-guiding surface are manufactured additively.

9. The laying-pipe segment according to claim 6, wherein the at least one contact point is a holding arm or a plate.

10. The laying pipe segment according to claim 1,
wherein the laying-pipe segment is configured to form the laying pipe together with at least one further laying-pipe segment;
wherein the laying-pipe segment alone is configured to form the laying pipe.

11. The laying-pipe segment according to claim 1, wherein the laying-pipe segment is manufactured from hard metal.

12. The laying-pipe segment according to claim 1, wherein the additive manufacturing method is a selective laser-sintering method.

13. A laying-pipe holder for holding a laying pipe, the laying pipe comprising holder elements and Integrally-formed functional elements joined undetachably to one another and produced using an additive manufacturing method, wherein the functional elements comprise at least one of rotatably held bearing bodies, solids of revolution, and stationary racks.

14. The laying-pipe holder according to claim 13, wherein the holder elements are manufactured additively.

15. The laying-pipe holder according to claim 13, wherein each holder element of the holder element represents a second component of a multi-component fastening system.

16. The laying-pipe holder according to claim 13, wherein each holder element of the holder elements has a cross-sectional face deviating from a plane.

17. The laying-pipe holder according to claim 13, wherein each holder element of the holder elements is connected in one piece with a central body of the laying-pipe holder.

18. The laying-pipe holder according to claim 13, wherein the additive manufacturing method is a selective laser-sintering method.

19. A laying-pipe holder for holding a laying pipe, the laying-pipe holder comprising rack parts joined undetachably to one another and comprising holder elements and at least one of rotatably held bearing bodies, solids of revolution, and stationary racks, wherein at least one rack part of the rack parts comprises a coolant channel or a coolant line and forms a functional element formed in one piece.

20. The laying-pipe holder according to claim 13, wherein the functional elements form a rack part containing a coolant channel or containing a coolant line or containing the holder elements.

21. An arrangement comprising the laying-pipe holder according to claim 13 and a laying pipe of at least one laying-pipe segment, wherein the laying-pipe holder is connected with the laying pipe via holder elements as first components of a two-component fastening system and via contact elements or contact faces as second components of the two-component fastening system.
